(19) United States
(12) Patent Application Publication
(10) Pub. No.: US 2023/0352669 A1
(43) Pub. Date: Nov. 2, 2023

(54) SI-BASED ANODES WITH CROSS-LINKED CARBON NANOTUBES

(71) Applicant: Enevate Corporation, Irvine, CA (US)

(72) Inventors: Younes Ansari, Irvine, CA (US); Qing Zhang, Irvine, CA (US); Benjamin Yong Park, Irvine, CA (US)

(21) Appl. No.: 17/733,793

(22) Filed: Apr. 29, 2022

(51) Int. Cl. H01M 4/38; H01M 4/04; H01M 4/62; H01M 10/0525

(52) U.S. Cl. CPC H01M 4/386; H01M 4/0404; H01M 4/0435; H01M 4/625; H01M 10/0525; H01M 2004/027

(57) ABSTRACT

Systems and methods are provided for Si-based anodes with cross-linked carbon nanotubes. A slurry for use in anodes may be mixed, with the slurry including an anode active material and a carbon-based additive, where the slurry may be used in forming an anode. The anode active material may yield a silicon-dominant anode when the slurry is used in forming the anode, and the carbon-based additive forms a mesh-like structure in the silicon-dominant anode. The carbon-based additive includes cross-linked carbon nanotubes (CNT).

### TECHNICAL FIELD

Aspects of the present disclosure relate to energy generation and storage. More specifically, certain implementations of the present disclosure relate to methods and systems for a Si-based anodes with cross-linked carbon nanotubes.

### BACKGROUND

Various issues may exist with conventional battery technologies. In this regard, conventional systems and methods, if any existed, for designing and producing batteries or components thereof may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for Si-based anodes with cross-linked carbon nanotubes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1A illustrates an example battery.

FIG. 1B illustrates an example battery management system (BMS) for use in managing operation of batteries.

FIG. 2 is a flow diagram of an example lamination process for forming a silicon-dominant anode cell.

FIG. 3 is a flow diagram of an example direct coating process for forming a silicon-dominant anode cell.

FIG. 4 is a graph diagram illustrating comparisons in discharge capacity characteristics when cells are operated with different anodes, including anodes comprising cross-linked carbon nanotubes (CNTs).

### DETAILED DESCRIPTION

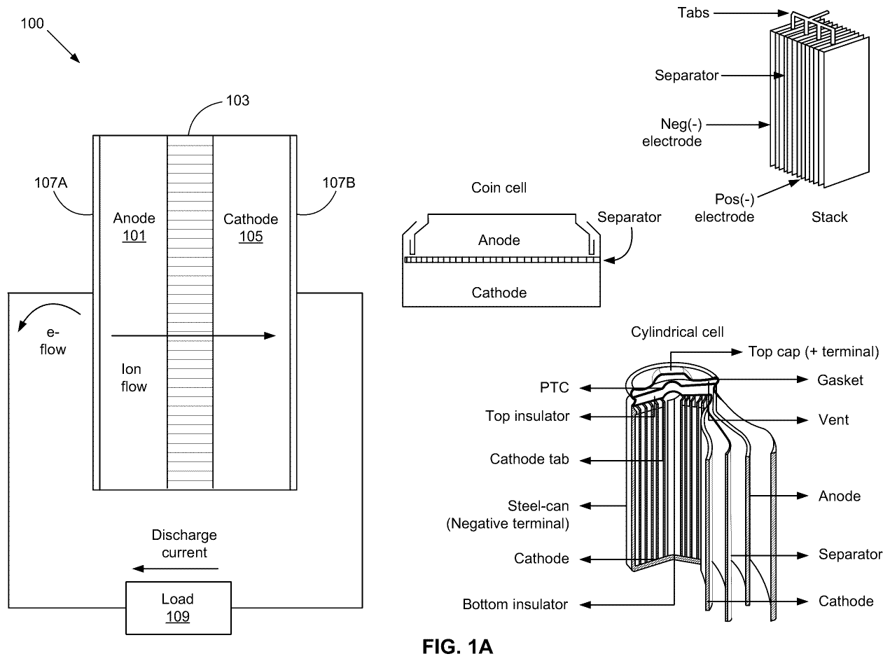

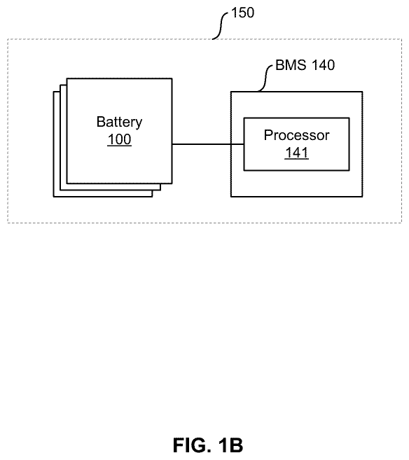

FIG. 1A illustrates an example battery. Referring to FIG. 1A, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1A is a very simplified example merely to show the principle of operation of a lithium ion cell. Examples of realistic structures are shown to the right in FIG. 1A, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

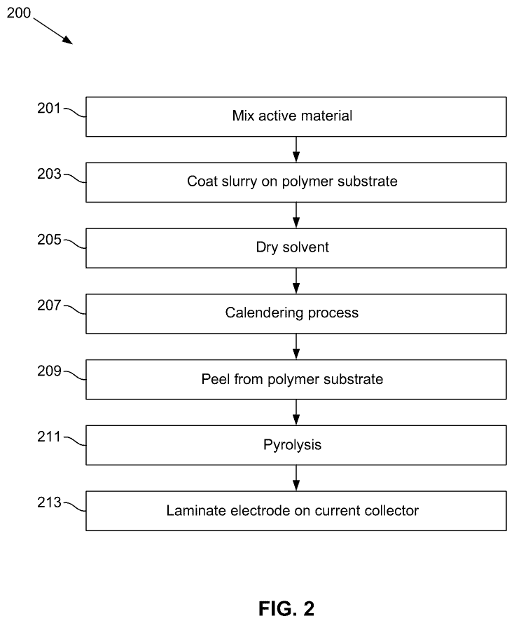

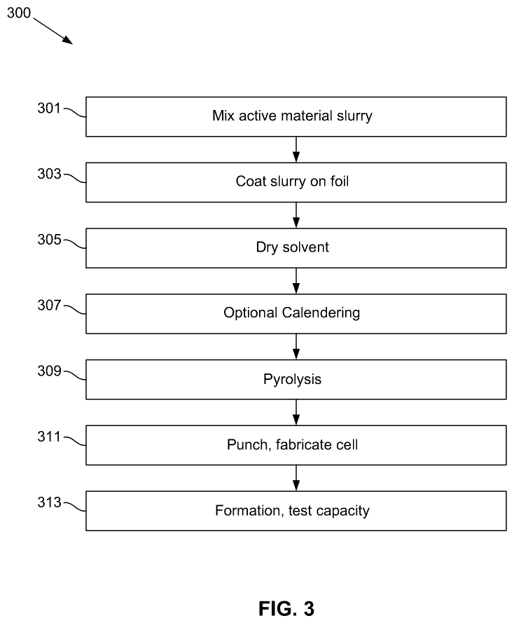

The configuration shown in FIG. 1A illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant anodes. For example, lamination or direct coating may be used in forming a silicon anode. Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70% by weight.

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1A for example, and vice versa through the separator 103 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super P), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used as such mixtures or combinations may be especially beneficial.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 1B.

In accordance with the present disclosure, electrodes (in particular anodes) may incorporate additives that are selected and/or configured to provide structures that enhance performance of the electrode. In particular, in various implementations, additives that may form mesh- or net-like structures (e.g., cross-linked carbon nanotubes (CNTs)) in the formed anodes may be used. In this regard, such additives may form a mesh or net—e.g., comprising fibers connected to each other, creating a structure that encapsulates the silicon particles. Such structure may offer various advantages—e.g., reducing expansion (e.g., in one or more of X-, Y-, and Z-directions) and improving conductivity, and may do so without adversely affecting other characteristics of the cell, such as cycle life. In this regard, silicon may expand considerably (e.g., up to three times its original volume) during lithiation.

Considerable volume expansion of Si may not only cause loss of physical contact between the particles, but may also lead to severe deformation of the electrode. The expansion along the planar dimensions of the electrode increases the probability of an internal short circuit of the cell and raises safety concerns. The presence of mesh- or net-like structure formed using additives such as CNT-based additives may address some of these issues. In particular, while the structure may not necessarily prevent the Si from expanding, it would prevent the pieces from falling apart, thus maintaining and/or improving cohesion of the anode. Thus, using high-aspect ratio CNT can improve conductivity of the electrode and alleviate the electrode cracking and disintegration during repeated cycling and reduce the anode expansion during lithiation upon charging.

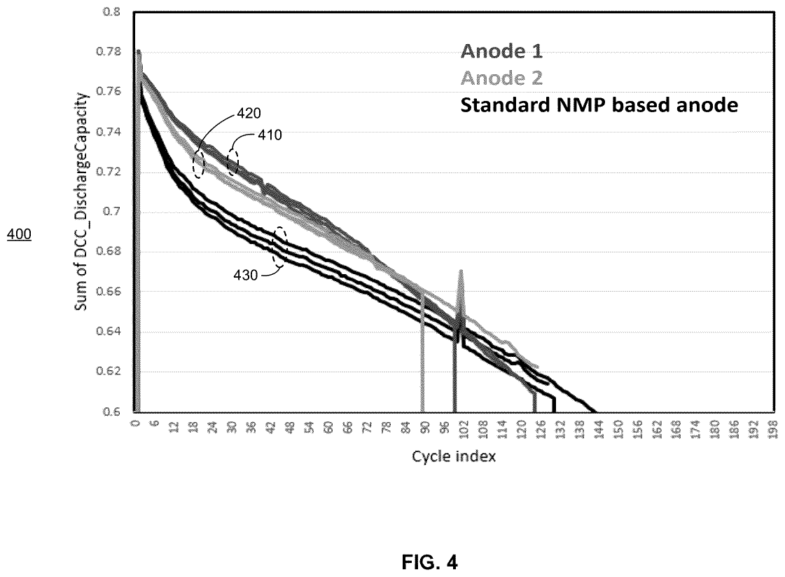

In various example implementations, an anode with an organic based resin or an anode with an aqueous based resin may be used, comprising cross-linked carbon nanotubes (CNTs). The amount of CNT used in such anodes may vary. In this regard, in various implementations, the amount of cross-linked carbon nanotubes (CNTs) in the anode (or in the slurry or mixtures used in forming the anode) may be up to 3% (i.e., 3 wt %) of the final anode active material layer as part of an anode electrode in a battery. An example anode in accordance with the present disclosure may be a Si-dominant anode with CNT. In such Si-dominant anode, the CNT may percolate and create a conductive network at low concentrations (e.g., <1%, <0.5%, or <0.25%). Further, such Si-dominant anode may have expansion (e.g., x-y expansion) of less than 1%, less than 0.8% with density higher than 1 gm/cm³, or 1.1 g/cm³. Also, such Si-dominant anode may have resistance less than 2 Ω·m, or 1.64 Ω·m. Example anodes (and formulations thereof) in accordance with the present disclosure are described below, such as with respect to FIG. 4.

FIG. 1B illustrates an example battery management system (BMS) for use in managing operation of batteries. Shown in FIG. 1B is battery management system (BMS) 140.

The battery management system (BMS) 140 may comprise suitable circuitry (e.g., processor 141) configured to manage one or more batteries (e.g., each being an instance of the battery 100 as described with respect with FIG. 1A). In this regard, the BMS 140 may be in communication and/or coupled with each battery 100.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components, and may only be in communication with one another when present in the same system. The disclosure is not limited to any particular arrangement, however.

FIG. 2 is a flow diagram of an example lamination process for forming a silicon-dominant anode cell. This process employs a high-temperature pyrolysis process on a substrate, layer removal, and a lamination process to adhere the active material layer to a current collector. This strategy may also be adopted by other anode-based cells, such as graphite, conversion type anodes, such as transition metal oxides, transition metal phosphides, and other alloy type anodes, such as Sn, Sb, Al, P, etc.

The raw electrode active material is mixed in step 201. In the mixing process, the active material may be mixed with a binder/resin (such as water soluble PI, PAI, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. silicon powder with a 1-30 or 5-30 μm particle size, for example, may then be dispersed in polyamic acid resin, polyamide-imide (PAI), or polyimide (15-25% solids in N-Methyl pyrrolidone (NMP) or DI water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes

The particle size and mixing times may be varied to configure the electrode coating layer density and/or roughness. Furthermore, cathode electrode coating layers may be mixed in step 201, where the electrode coating layer may comprise lithium cobalt oxide (LCO), lithium iron phosphate, lithium nickel cobalt manganese oxide (NMC), Ni-rich lithium nickel cobalt aluminum oxide (NCA), lithium manganese oxide (LMO), lithium nickel manganese spinel, LFP, Li-rich layer cathodes, LNMO or similar materials or combinations thereof, mixed with carbon precursor and additive as described above for the anode electrode coating layer.

In step 203, the slurry may be coated on a substrate. In this step, the slurry may be coated onto a Polyester, polyethylene terephthalate (PET), or Mylar film at a loading of, e.g., 2-4 mg/cm² and then undergo drying in step 205 to an anode coupon with high Si content and less than 15% residual solvent content. This may be followed by an optional calendering process in step 207, where a series of hard pressure rollers may be used to finish the film/substrate into a smoothed and denser sheet of material.

In step 209, the green film may then be removed from the PET, where the active material may be peeled off the polymer substrate, the peeling process being optional for a polypropylene (PP) substrate, since PP can leave ˜2% char residue upon pyrolysis. The peeling may be followed by a pyrolysis step 209 where the material may be heated to 600-1250° C. for 1-3 hours, cut into sheets, and vacuum dried using a two-stage process (120° C. for 15 h, 220° C. for 5 h).

In step 213, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The cell may be assessed before being subject to a formation process. The measurements may comprise impedance values, open circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

FIG. 3 is a flow diagram of an example direct coating process for forming a silicon-dominant anode cell. This process comprises physically mixing the active material, conductive additive, and binder together, and coating it directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed, e.g., a binder/resin (such as PI, PAI or phenolic), solvent (such as NMP, DI water or other environmentally benign solvents or their mixtures and combinations thereof), and conductive additives. The materials may comprise carbon nanotubes/fibers, graphene sheets, metal polymers, metals, semiconductors, and/or metal oxides, for example. silicon powder with a 1-30 μm particle size, for example, may then be dispersed in polyamic acid resin, polyamide-imide, polyimide (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a calendering process for densification followed by pyrolysis (500-800° C.) such that carbon precursors are partially or completely converted into glassy carbon or pyrolytic carbon. Similarly, cathode active materials may be coated on a foil material, such as aluminum, for example. The active material layer may undergo a drying in step 305 resulting in reduced residual solvent content. An optional calendering process may be utilized in step 307 where a series of hard pressure rollers may be used to finish the film/substrate into a smoother and denser sheet of material. In step 307, the foil and coating proceeds through a roll press for lamination.

In step 309, the active material may be pyrolyzed by heating to 500-1000° C. such that carbon precursors are partially or completely converted into glassy carbon. Pyrolysis can be done either in roll form or after punching. If done in roll form, the punching is done after the pyrolysis process. The pyrolysis step may result in an anode active material having silicon content greater than or equal to 50% by weight, where the anode has been subjected to heating at or above 400 degrees Celsius. In an example scenario, the anode active material layer may comprise 20 to 95% silicon and in yet another example scenario may comprise 50 to 95% silicon by weight. Pyrolysis can be done either in roll form or after punching in step 311. If done in roll form, the punching is done after the pyrolysis process. In instances where the current collector foil is not pre-punched/pre-perforated, the formed electrode may be perforated with a punching roller, for example. The punched electrodes may then be sandwiched with a separator and electrolyte to form a cell. In some instances, separator with significant adhesive properties, in accordance with the present disclosure, maybe utilized.

In step 313, the cell may be assessed before being subject to a formation process. The measurements may comprise impedance values, open circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

FIG. 4 is a graph diagram illustrating comparisons in discharge capacity characteristics when cells are operated with different anodes, including anodes comprising CNT. Shown in FIG. 4 is graph 400.

The graph 400 illustrates results of example operation runs of example Si/Li cell (battery) cells, with the graph 400 specifically capturing discharge capacity of the cells as a function of number of cycles for each run. The cells comprise one of three different anodes, with two (referred to as “Anode 1” and “Anode 2”) being CNT-based anodes with the organic based resin, and the third anode (referred to as “Reference 1”) not comprising CNT.

With respect to anode composition, for Anode 1 and Anode 2 a slurry comprising 32.55% silicon powder, 57.27% PAI solution (12%) in NMP, 10% NMP and 0.18% cross-linked CNT may be used. Once the slurry is prepared it may be coated on foil (e.g., 15 μm copper foil). The CNT may be carbon nanostructure material. The NMP may be used as a solvent. The disclosure is not limited to the specific formulations described herein, however, and as such some of the percentages noted herein may be adjusted. For example, in some implementations, an amount of CNT is increased, such as up to 3%.

For Anode 1, the coated anode is calendared at 70° C., punched to small pouches and pyrolyzed at 600° C., 5° C./min ramp, and 120 min dwell time under Argon (Ar) atmosphere. The final loading of the anode is 3.41 mg/cm². The final composition after pyrolysis is Si/carbon/CNT=90/9.5/0.5. The final thickness is 82.5 μm, and porosity is about 55.9%. For Anode 2, the coated anode is calendared at 70° C., punched to small pouches and pyrolyzed at 600° C., 5° C./min ramp, and 120 min dwell time under Ar/H₂ forming gas. The final loading of the anode is 3.44 mg/cm². The final composition after pyrolysis is Si/carbon/CNT=90/9.5/0.5. The final thickness is 82.1 μm, and porosity is about 55.0%.

For Reference 1 anode, a slurry comprising 27.9% silicon powder, 51.66% PAI solution (12%) in NMP, and 20.44% NMP may be used. Once the slurry is prepared it may be coated on foil (e.g., 15 μm copper foil). The coated anode is calendared at 150° C., punched to small pouches and pyrolyzed at 600° C., 5° C./min ramp, and 120 min dwell time under Ar/H₂ forming gas. The final loading of the anode is 3.55 mg/cm². The final composition after pyrolysis is Si/carbon=90/10. The final thickness is 78.6 μm, and porosity is about 51.1%. This anode is denoted as Reference 1.

The graph 400 includes line graphs 410, 420 and 430, comprising results corresponding to operating cells with, respectively, Anode 1, Anode 2, and Reference 1 anode, under the same cycling conditions. As shown, the two anodes with CNT additives have comparable cycle life as the standard anode (i.e., the Reference 1 anode).

As noted above, use of anodes with CNT additives may yield enhanced performance, such as with respect to other characteristics (e.g., expansion and resistivity). For example, as illustrated in Table 1, resistivity tests on Anode 1, Anode 2, and Reference 1 anode show that the anodes with CNT additives exhibit lower resistance. In this regard, the resistivity tests may comprise measuring through resistance by sandwiching 16 mm diameter anode disk between two blocking electrodes with a diameter of 9.98 mm and area of 0.78 cm² at a pressure of 14.5 psi.

TABLE 1
Resistivity of Anode 1, Anode
2 and Reference 1 anode

| Anode | Resistivity (Q · m) |
|---|---|
| Anode 1 | 1.64 |
| Anode 2 | 1.93 |
| Reference 1 | 9.18 |

Similarly, expansion tests on Anode 1, Anode 2, and Reference 1 anode show that the anodes with CNT additives exhibit enhanced expansion performance. In this regard, for testing expansion, the anodes may be cycled against LiNi_{0.8}Mn_{0.1} Co_{0.1}O₂ (NMC811) cathode (92% active ratio and 23 mg/cm² loading) in a pouch cell format. Formation of cells is performed at 1 C for charge and 1 C for discharge in the 4.2-2.0 V voltage range, with a 0.05 C current taper at the end of charge and a 0.2 C current taper at the end of discharge. Constant current cycling is performed at 2 C for charge and 0.5 C for discharge in the 4.2-2.75 V voltage range. Cell capacity is 0.78 Ah. Anode dimensions are measured after the formation process to evaluate expansion along the X and Y axis. Table 2 shows the results of expansion testing of Anode 1, Anode 2 and Reference 1 anode, with both anodes comprising CNT additives (Anode 1 and Anode 2) showing much lower XY expansion compared to Reference 1 anode:

TABLE 2
XY expansion of Anode 1,
Anode 2 and Reference 1 anode

| | Density | Porosity | X | Y |
|---|---|---|---|---|
| Anode | (g/cm) | % | % | % |
| Anode 1 | 1.01 | 55.9% | 0.53% | 0.41% |
| Anode 2 | 1.03 | 55.0% | 0.64% | 0.57% |
| Reference 1 | 1.12 | 51.1% | 1.19% | 0.92% |

While the anodes with CNT additives described above are anodes with the organic based resin, similar results may be observed with other types of anodes with CNT additives, such as anodes with the aqueous based resin. For example, in another set of tests, two anodes may similarly be tested, with one (referred to as “Anode 3”) being a CNT-based anode with the aqueous based resin, and the other anode (referred to as “Reference 2”) not comprising CNT.

With respect to anode composition for Anode 3, a slurry comprising 16.23% silicon powder, 56.33% PAI solution (6%) in water, 22.55% CNT dispersion in water (0.4%), 4.81% polyvinyl alcohol (PVA) solution in water (11.8%), and 0.08% surfactant may be used. Once the slurry is prepared it may be coated on foil (e.g., a 15 μm copper foil). The CNT used in this formulation is the carbon nanostructure material. With respect to anode formation, for Anode 3, the coated anode is calendared at 70° C., punched to small pouches and pyrolyzed at 650° C., 5° C./min ramp, and 180 min dwell time under Ar/H₂ forming gas. The final loading of the anode is 3.48 mg/cm². The final composition after pyrolysis is Si/carbon/CNT=90/9.5/0.5. The final thickness is 78.7 μm, and porosity is about 51.6%.

For Reference 2 anode, a slurry comprising 19.63% silicon powder, 62.88% PAI solution (6%) in water, 17.41% PVA solution in water (11.8%), and 0.08% surfactant may be used may be used. Once the slurry is prepared it may be coated on foil (e.g., 15 μm copper foil). The coated anode is calendared at 70° C., punched to small pouches and pyrolyzed at 650° C., 5° C./min ramp, and 180 min dwell time under Ar. The final loading of the anode is 3.29 mg/cm². The final composition after pyrolysis is Si/carbon=90/10. The final thickness is 79.0 μm, and porosity is about 49.0%.

As noted above, use of anodes with CNT additives may yield enhanced performance, such as with respect to such characteristics as expansion and resistivity. For example, as illustrated in Table 3, resistivity tests on Anode 3 and Reference 2 anode show that the anodes with CNT additives exhibit lower resistance. In this regard, the resistivity tests may comprise measuring through resistance by sandwiching 16 mm diameter anode disk between two blocking electrodes with a diameter of 9.98 mm and area of 0.78 cm² at a pressure of 14.5 psi.

TABLE 3
Resistivity of Anode 3
and Reference 2 anode

| Anode | Resistivity (Q · m) |
|---|---|
| Anode 3 | 2.31 |
| Reference 2 | 4.30 |

Similarly, expansion tests on Anode 3 and Reference 3 anode show that the anodes with CNT additives exhibit enhance expansion performance. In this regard, for testing expansion, the anodes may be cycled against LiNi_{0.8}Mn_{0.1} Co_{0.1}O₂ (NMC811) cathode (92% active ratio and 23 mg/cm² loading) in a pouch cell format. Formation of cells is performed at 1 C for charge and 1 C for discharge in the 4.2-2.0 V voltage range, with a 0.05 C current taper at the end of charge and a 0.2 C current taper at the end of discharge. Constant current cycling is performed at 2 C for charge and 0.5 C for discharge in the 4.2-2.75 V voltage range. Cell capacity is 0.78 Ah. Anode dimensions are measured after the formation process to evaluate expansion along X and Y axis. Table 4 shows the results of expansion testing of Anode 3 and Reference 2 anode, with Anode 3 showing lower XY expansion compared to Reference 2 anode.

TABLE 4
XY expansion of Anode 3 and Reference 2 anode

| Anode | Density (g/cm) | Porosity % | X % | Y % |
|---|---|---|---|---|
| Anode 3 | 1.11 | 51.6% | 0.72% | 0.58% |
| Reference 2 | 1.11 | 41.0% | 0.84% | 0.90% |

An example slurry for use in anodes, in accordance with the present disclosure, comprises an anode active material that yields a silicon-dominant anode when the slurry is used in forming the anode; and a carbon-based additive that forms a mesh-like structure in the silicon-dominant anode.

An example electrochemical cell, in accordance with the present disclosure, comprises a silicon-dominant anode; a cathode; a separator; and an electrolyte; wherein the silicon-dominant anode that comprises an anode active material and a carbon-based additive that forms a mesh-like structure.

In an example embodiment, the carbon-based additive comprises cross-linked carbon nanotubes (CNTs).

In an example embodiment, the carbon-based additive percolates and creates in the silicon-dominant anode a conductive network at low concentration, and wherein the low concentration is <1%, <0.5%, or <0.25%.

In an example embodiment, the silicon-dominant anode has, as a result of forming of the mesh-like structure, an expansion of less than 1%, or less than 0.8%, with density higher than 1 gm/cm³, or higher than 1.1 g/cm³.

In an example embodiment, the silicon-dominant anode has, as a result of forming of the mesh-like structure, resistance less than 5 Ω·m, less than 2 Ω·m, or less than 1.64 Ω·m.

In an example embodiment, the silicon-dominant anode comprises a pyrolyzed carbon-based binder.

In an example embodiment, the slurry comprises a precursor for the pyrolyzed carbon-based binder.

In an example embodiment, the precursor for the pyrolyzed carbon-based binder is dispersed in an organic based solvent, an inorganic based solvent, or a mixture of organic and inorganic solvents.

In an example embodiment, the organic based solvent used in the slurry comprises N-Methyl pyrrolidone (NMP) based solvent.

In an example embodiment, the pyrolyzed carbon-based binder comprises a pyrolytic carbon derived from polyamide-imide (PAI).

In an example embodiment, the slurry further comprises polyvinyl alcohol (PVA) solution in water. In some instance, the slurry may comprise any one or combination of: Nuciferine galactose maltose Ammonium Lignosulfonate Kraft Lignin Formaldehyde based Resins melamine-formaldehyde based resins Silane based resins (gelest), silicones polyurethanes poly(vinyl acetate)/poly(vinyl alcohol) complexes TOCRYL (acrylic emulsion) poly(methacrylic acid) polymethyl methacrylate ACRONAL water-based acrylic and stryrene-acrylic emulsion polymers STYROFAN carboxylated styrene-butadiene binders Acrylic Resins poly (acrylic acid) glycogen carbohydrates (other) polymers with the following backbones Cellulose crystals, cellulose nano-crystals HEC (Hydroxy Ethyl Cellulose) CMHEC (Carboxy methyl hydroxy ethyl cellulose) cellulose Starch Pullulan (polysaccharide polymer) Dextran Chitosan Helios Resins (DOMOPOL [polyester], DOMACRYL [polyacrylic], DOMALKYD [polyester] and DOMEMUL [styrene/acrylic]) rotaxane polymeric microbeads Polyethylene oxide Polyethylene glycol.

In an example embodiment, the slurry further comprises a surfactant.

In an example embodiment, a precursor for the carbon-based additive is dispersed in water.

An example method for forming anodes, in accordance with the present disclosure, comprises mixing a slurry for use in anodes, the slurry comprising an anode active material and a carbon-based additive; and forming an anode using the slurry; wherein: anode active material yields a silicon-dominant anode when the slurry is used in forming the anode; and the carbon-based additive forms a mesh-like structure in the silicon-dominant anode.

In an example embodiment, the carbon-based additive comprises cross-linked carbon nanotubes (CNT).

In an example embodiment, the carbon-based additive percolates and creates in the final silicon-dominant anode a conductive network at low concentration, and wherein the low concentration is <1%, <0.5%, or <0.25%.

In an example embodiment, the silicon-dominant anode has, as a result of forming of the mesh-like structure, an expansion of less than 1%, or less than 0.8%, with density higher than 1 gm/cm³, or higher than 1.1 g/cm³.

In an example embodiment, the silicon-dominant anode has, as a result of forming of the mesh-like structure, resistance less than 2 Ω·m, or less than 1.64 Ω·m.

In an example embodiment, the method further comprises forming the silicon-dominant anode using a direct coating process of the slurry on a current collector to provide a coated anode.

In an example embodiment, the method further comprises calendaring the coated anode.

In an example embodiment, the method further comprises calendaring the coated anode at 70° C.

In an example embodiment, the method further comprises pyrolyzing the coated anode at >500° C., 5° C./min ramp, and 60-120 min dwell time under Argon (Ar) atmosphere.

In an example embodiment, the method further comprises pyrolyzing the coated anode at >500° C., 5° C./min ramp, and 60-120 min dwell time under Ar/H₂ forming gas.

In an example embodiment, the method further comprises pyrolyzing the coated anode at >500° C., 5° C./min ramp, and 120-180 min dwell time under N₂ nitrogen gas.

In an example embodiment, the method further comprises pyrolyzing the coated anode at >500° C., 5° C./min ramp, and 120-180 min dwell time under Argon (Ar) atmosphere.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An electrochemical cell comprising:
a silicon-dominant anode;
a cathode;
a separator; and
an electrolyte;
wherein the silicon-dominant anode comprises an anode active material and a carbon-based additive that forms a mesh or net structure comprising carbon fibers and/or tubes connected to each other.

2. The electrochemical cell of claim 1, wherein the carbon-based additive comprises cross-linked carbon nanotubes (CNTs).

3. The electrochemical cell of claim 1, wherein the carbon-based additive percolates and creates in the silicon-dominant anode a conductive network at low concentration, and wherein the low concentration is <1%, <0.5%, or <0.25%.

4. The electrochemical cell of claim 1, wherein the silicon-dominant anode has, as a result of forming of the mesh or net structure, an expansion of less than 1%, or less than 0.8%, with density higher than 1 gm/cm³, or higher than 1.1 g/cm³.

5. The electrochemical cell of claim 1, wherein the silicon-dominant anode has, as a result of forming of the mesh or net structure, resistance less than 5 Ω·m, less than 2 Ω·m, or less than 1.64 Ω·m.

6. The electrochemical cell of claim 1, wherein the silicon-dominant anode comprises a pyrolyzed carbon-based binder.

7. The electrochemical cell of claim 6, wherein the slurry comprises a precursor for the pyrolyzed carbon-based binder.

8. The electrochemical cell of claim 7, wherein the precursor for the pyrolyzed carbon-based binder is dispersed in an organic based solvent, an inorganic based solvent, or a mixture of organic and inorganic solvents.

9. The electrochemical cell of claim 8, wherein the organic based solvent used in the slurry comprises N-Methyl pyrrolidone (NMP) based solvent.

10. The electrochemical cell of claim 6, wherein the pyrolyzed carbon-based binder comprises a pyrolytic carbon derived from polyamide-imide (PAI).

11. The electrochemical cell of claim 1, wherein the slurry further comprises polyvinyl alcohol (PVA) solution in water.

12. The electrochemical cell of claim 1, wherein the slurry further comprises a surfactant.

13. The slurry used to make electrodes of claim 1, wherein a precursor for the carbon-based additive is dispersed in water.

14. A method comprising:
mixing a slurry for use in anodes, the slurry comprising an anode active material and a carbon-based additive; and
forming an anode using the slurry;
wherein:
the anode active material yields a silicon-dominant anode when the slurry is used in forming the anode; and
the carbon-based additive forms a mesh or net structure in the silicon-dominant anode, the mesh or net structure comprising carbon fibers and/or tubes connected to each other.

15. The method of claim 14, wherein the carbon-based additive comprises cross-linked carbon nanotubes (CNT).

16. The method of claim 14, wherein the carbon-based additive percolates and creates in the final silicon-dominant anode a conductive network at low concentration, and wherein the low concentration is <1%, <0.5%, or <0.25%.

17. The method of claim 14, wherein the silicon-dominant anode has, as a result of forming of the mesh or net structure, an expansion of less than 1%, or less than 0.8%, with density higher than 1 gm/cm³, or higher than 1.1 g/cm³.

18. The method of claim 14, wherein the silicon-dominant anode has, as a result of forming of the mesh or net structure, resistance less than 2 Ω·m, or less than 1.64 Ω·m.

19. The method of claim 14, comprising forming the silicon-dominant anode using a direct coating process of the slurry on a current collector to provide a coated anode.

20. The method of claim 19, further comprising calendaring the coated anode.

21. The method of claim 20, further comprising calendaring the coated anode at 70° C.

22. The method of claim 21, further comprising pyrolyzing the coated anode at >500° C., 5° C./min ramp, and 60-120 min dwell time under Argon (Ar) atmosphere.

23. The method of claim 21, further comprising pyrolyzing the coated anode at >500° C., 5° C./min ramp, and 60-120 min dwell time under Ar/H₂ forming gas.

24. The method of claim 21, further comprising pyrolyzing the coated anode at >500° C., 5° C./min ramp, and 120-180 min dwell time under N₂ nitrogen gas.

25. The method of claim 21, further comprising pyrolyzing the coated anode at >500° C., 5° C./min ramp, and 120-180 min dwell time under Argon (Ar) atmosphere.
